(19) United States
(12) Patent Application Publication
(10) Pub. No.: US 2010/0027037 A1
(43) Pub. Date: Feb. 4, 2010

(54) Image Processing Controller and Image Processing Apparatus

(75) Inventor: Toyoaki KUWAHARA, Nagano-ken (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/498,925

(22) Filed: Jul. 7, 2009

(30) Foreign Application Priority Data
Aug. 1, 2008 (JP) 2008-199583

(51) Int. Cl. H04N 1/60

(52) U.S. Cl. 358/1.9

(57) ABSTRACT

An image processing controller inputs image data representing a tone for each pixel into a processing unit via a bus that offers a predetermined transfer speed. A first substituting section renders a given number of low order bits in a tone value of the image data redundant and includes information on the number of bits rendered redundant in the image data. A compressing section compresses image data subjected to the redundancy processing. A decompressing section decompresses compressed image data acquired from a storing section via the bus when the amount of stored compressed image data reaches a predetermined amount. A second substituting section obtains the information on the number of bits rendered redundant included in the decompressed image data and replaces these bits with non-redundant data.

### BACKGROUND

1. Technical Field

The present invention generally relates to an image processing controller and an image processing apparatus. In particular, the invention relates to an image processing controller that inputs, into a processing unit that processes image data that represents a tone for each pixel in a non-interruptive manner by a predetermined amount at a time, the image data via a bus that offers a predetermined transfer speed, and further relates to an image processing apparatus that is provided with such an image processing controller.

2. Related Art

In the operation of a photosensitive member such as a photosensitive drum of a laser printer, it is necessary to input a predetermined amount of data (e.g., print data for one page) in a non-interruptive batch transfer without any pause at a predetermined transfer speed, which is a speed that corresponds to the rotation speed of the drum. There is a plurality of rate-determining steps, which limit the speed of inputting a signal into a processing unit. A few examples of such rate-limiting steps are: raster data creation processing that is performed on the basis of a PDL language of an inputted print job, the transfer speed of a bus via which the signal is inputted, among others.

In the operation of a laser printer, it is known in the art that, in order to achieve stable data transfer at a constant speed, predetermined amount of data is temporarily stored in a buffer and then sequentially read out of the buffer, thereby ensuring that the raster data creation processing, which is not uniform in terms of an output speed, does not affect the inputting speed of a signal. Generally speaking, the speed of computation such as the speed of the arithmetic operation of an IC is higher than the transfer speed of a bus. In view of this fact, it is also known in the art that it is possible to increase the transfer speed of a bus by performing data compression prior to the buffering thereof. An example of the related art described above is described in JP-A-2004-42325.

These days, there is a demand for further increasing a data transfer speed, which is necessitated as the resolution of image data becomes higher and higher. As a solution to meet the needs described above, a method for increasing the compression ratio of data that has a high resolution has been proposed as described in the publication of the Japanese unexamined patent application identified above. Specifically, according to the proposed method, the low tone part of pre-compression data is put into a missing state so as to make it easier to encode the data. For example, the low tone data is replaced with zero or one. However, if the low tone data is put into a missing state as in the proposed method explained above in a case where the image data includes continuous tone representation (i.e., gradation), fine nuances contained in the original tone representation will be lost and not reproduced, which results in discontinuity in tone reproduction.

### SUMMARY

An advantage of some aspects of the invention is to provide an image processing controller that is capable of, when image data that represents a tone for each pixel is inputted into a processing unit that processes the image data in a non-interruptive manner by a predetermined amount at a time via a bus that offers a predetermined transfer speed, preventing the data creation speed of a functional block that is provided at an upstream stage when viewed from the processing unit from affecting the processing speed of the processing unit, ensuring that the processing of the processing unit is not interrupted or delayed, and making discontinuity in tone representation in the image data that is inputted into the processing unit substantially less noticeable. The invention further provides, as an advantage of some aspects thereof, an image processing apparatus that is provided with such an image processing controller. For example, the image processing apparatus having the features explained above can be embodied as a laser printer without any limitation thereto.

In order to address the above-identified problems without any limitation thereto, the invention provides, as a first aspect thereof, an image processing controller that inputs image data into a processing unit via a bus that offers a predetermined transfer speed. The processing unit processes the image data in a non-interruptive manner by a predetermined amount at a time. The image data represents a tone for each pixel. An image processing controller according to the first aspect of the invention includes a first substituting section, a storing section, a compressing section, a decompressing section, and a second substituting section.

In the configuration of an image processing controller according to the first aspect of the invention described above, the compressing section compresses the image data before it is stored in the storing section (e.g., memory). The decompressing section acquires the image data stored in the storing section via the bus when the amount of the image data stored in the storing section reaches the predetermined amount and then decompresses the image data acquired therefrom. The computing speed of the decompression processing is higher than the transfer speed of the bus. For this reason, under no circumstances does the computing speed of the decompression processing limits, as a rate-determining step, the speed of inputting the image data into the processing unit. This means that it is possible to input the image data into the processing unit at a speed that is not lower than the transfer speed of the bus.

Before the compression of the image data, the first substituting section renders a given number of low order bits in a tone value of the image data redundant. Therefore, the degree of redundancy of the processed image data is higher than that of non-processed original image data. For this reason, as a result of compression processing that is performed by the compressing section, data amount per pixel is reduced. Thus, when the image data is transferred via the bus that offers the predetermined transfer speed, the transfer speed per unit volume of the image data further increases. Needless to say, it also contributes to the saving of memory capacity because the compression ratio per unit volume of the image data improves.

In addition, the first substituting section adds information on the number of bits rendered redundant to each pixel. The second substituting section obtains the information on the number of bits rendered redundant from each pixel of the image data that has been subjected to decompression processing. Then, the second substituting section replaces the bits that were rendered redundant by the first substituting section with non-redundant data so as to recover the tone characteristics of the image data. The non-redundant data mentioned herein means information whose so-called information entropy is increased. For example, the non-redundant data is data that has high random characteristics such as noise or the like. The non-redundant data may be generated with the use of noise. Or, pseudo-random data that is generated on the basis of a pseudo-random generation algorithm may be used. Therefore, it is possible to increase the transfer speed per unit volume of image data so as to meet the demand for the transfer of image data that has a higher resolution. In addition, it is further possible to make discontinuity in tone representation in image data substantially less noticeable.

The term “predetermined amount” means the unit processing volume of the processing unit. The “predetermined amount” of data means or corresponds to a certain indivisible amount of data for which processing cannot be suspended before the completion thereof by the nature of the processing. For example, in the case of the print processing of a laser printer, print data for one page corresponds to the predetermined amount of data mentioned above. The phrase “processes—in a non-interruptive manner” means that a certain processing speed is ensured. The phrase “processes—in a non-interruptive manner by a predetermined amount at a time” means that processing is not interrupted or delayed during the execution thereof for a certain amount of data. The term “bus” means a communication path (i.e., transfer path) that connects one circuit and another so as to be used for the transferring of a signal. Generally speaking, a bus transfer speed is lower than a computation processing speed. In the configuration of an image processing controller according to the first aspect of the invention described above, the predetermined transfer speed that is offered by the bus is lower than the computation processing speed of the processing unit. The phrase “renders—redundant” means that data is replaced with one that causes a decrease in information entropy when encoded through, for example, compression processing or the like. As a result of such redundancy processing, the compression ratio of the image data increases. The phrase “includes—in the image data” means that information that indicates the number of bits is described in a null bit(s) of the image data. The term “null bit” used here means, for example, an open, empty, or vacant bit. For example, it is possible to record the number of bits rendered redundant in a channel that is provided for the recording of additional information, including but not limited to, an X channel or an a channel. Needless to say, an additional data channel in which the number of bits rendered redundant can be recorded may be provided. The “non-redundant data” is, for example, random data (or pseudo-random data) or irregular data such as noise or the like. Since the second substituting section replaces missing data with non-redundant data, it is possible to increase information entropy that was decreased by the first substituting section.

In the configuration of an image processing controller according to the first aspect of the invention described above, it is preferable that each pixel of the image data should have information that indicates a type of an object that is made up of the pixels; and the first substituting section should change the number of bits rendered redundant depending on the type of the object. The type of an object includes a so-called “image” image, a character image, and a photo image without any limitation thereto. The level of importance of keeping the tone characteristics of image data, that is, how important it is, varies from one to another depending on the type of an object. For example, if the tone characteristics of a photo image are lost, discontinuity in tone will be conspicuous as tone jump. In contrast, if the object type is a solid image such as characters or the like, minor loss in tone reproduction will be hard to be noticed. That is, it is preferable to change the number of bits rendered redundant depending on the type of an object that is made up of pixels inclusive of a target pixel (i.e., a pixel in question). By this means, it is possible to perform redundancy processing while making tone jump hard to be noticed.

Specifically, the number of bits rendered redundant may be set at a value that is smaller than a certain value (or redundancy processing may be skipped) for pixel data that make up such a type of an object that will suffer an observable tone jump problem if the tone characteristics thereof are degraded, whereas the number of bits rendered redundant may be set at a value that is not smaller than the value mentioned above (e.g., two bits) for pixel data that make up such a type of an object whose tone jump is hard to be observed even when the tone characteristics thereof are degraded. An example of the type of an object whose tone jump will be likely to become conspicuous due to the degradation of the tone characteristics thereof is a picture image such as a so-called “image” image, a photo image, and the like. An example of the type of an object whose tone jump is hard to be noticed, or at least less noticeable, even when the tone characteristics thereof are degraded is a character image.

In the configuration of an image processing controller according to the first aspect of the invention described above, it is preferable that the first substituting section should include the information on the number of bits rendered redundant in attribute information description bits of the image data. Generally speaking, image data sometimes has an information channel such as an X channel that is provided for the storage of attribute information such as one that indicates which object each pixel belongs to, in addition to information on the brightness/luminosity of an image and the chroma saturation thereof. In a typical data bit configuration, the same number of bits as that of each of channels that is used for the storage of the corresponding one of color components of image data is allocated for the X channel. Therefore, the X channel has empty bits (i.e., null bits). In addition, some bits become unused after the conversion of image data into raster data. These empty bits or unused bits may be used for the writing of other data therein. That is, the information on the number of bits rendered redundant can be stored in bits that are used at a functional block(s) that is provided at an upstream position when viewed from the first substituting section but are not used at the second substituting section. Image data typically has an a channel as an information channel that is used for the storing of the transparency (i.e., transmission factor) of each pixel. Since the α channel is not used after the conversion of image data into raster data, it is possible to use the α channel for the storing of the information on the number of bits rendered redundant therein. Thus, it is possible to effectively use a channel that is originally provided in image data and communicate information on the number of bits rendered redundant mentioned above to a downstream processing block.

In order to address the foregoing problems without any limitation thereto, the invention may be configured as a second aspect as follows. That is, an image processing controller according to the second aspect inputs, into a processing unit that processes image data that represents a tone for each pixel in a non-interruptive manner by a predetermined amount at a time, the image data via a bus that offers a predetermined transfer speed. The image processing controller according to the second aspect includes: a first substituting section that renders a predetermined number of low order bits in a tone value of the image data redundant; a storing section that stores the image data; a compressing section that compresses the image data that has been subjected to redundancy processing mentioned above and then stores the compressed image data into the storing section; a decompressing section that acquires the image data stored in the storing section via the bus when the amount of the image data stored in the storing section reaches the predetermined amount and then decompresses the image data acquired therefrom; and a second substituting section that replaces the predetermined number of low order bits of the image data that has been subjected to decompression processing mentioned above with non-redundant data and then inputs the image data into the processing unit. That is, if the number of bits rendered redundant has been determined in advance, it is not necessary to communicate information on the number of bits rendered redundant from the upstream first substituting section to the downstream second substituting section.

The image processing controller described above can be embodied in various modes and manners. For example, it may be built as a component of other apparatus. Or, it may be embodied as a controller that performs processing described above in addition to other processing. Specifically, the concept of the present invention can also be embodied as an image processing apparatus that is provided with the image processing controller described above, for example, a printing apparatus that is provided with the image processing controller described above, or a printing system that is provided with such a printing apparatus. The concept of the present invention can also be embodied as a controlling method that includes operation procedures (e.g., steps, but not limited thereto) that correspond to the constituent elements of the image processing controller described above. Or, it can also be embodied as a program that causes a computer to execute functions that correspond to the constituent elements of the image processing controller described above. Or, it may be embodied as a computer readable storage medium in which such a program is stored. The printing apparatus, the printing system, the image processing method, the image processing program, and the storage medium in which the program is stored offer the advantages and effects described above. Needless to say, the system, the method, the program, and/or the storage medium can be applied to the image processing controller that has the features described in any of the appended claims 2 to 5.

### BRIEF DESCRIPTION OF THE DRAWINGS

The invention will be described with reference to the accompanying drawings, wherein like numbers reference like elements.

FIG. 1 is a block diagram that schematically illustrates an example of the configuration of a laser printer according to an exemplary embodiment of the invention.

FIG. 2 is a diagram that schematically illustrates an example of the concept of redundancy processing according to an exemplary embodiment of the invention.

FIG. 3 is a diagram that schematically illustrates an example of the concept of missing-bit complementing processing according to an exemplary embodiment of the invention.

FIG. 4 is a diagram that schematically illustrates, as an input/output curve, an example of a γ-correction table according to an exemplary embodiment of the invention.

FIG. 5 is a diagram that schematically illustrates, as an input/output curve, an example of a γ-correction table according to an exemplary embodiment of the invention.

FIG. 6 is a diagram that schematically illustrates, as an input/output curve, an example of a γ-correction table according to an exemplary embodiment of the invention.

FIG. 7 is a diagram that schematically illustrates an example of the configuration of a missing-bit complementing processing unit according to an exemplary embodiment of the invention.

FIG. 8 is a diagram that schematically illustrates an example of the configuration of a γ-correction processing unit and a halftone processing unit according to an exemplary embodiment of the invention.

### DESCRIPTION OF EXEMPLARY EMBODIMENTS

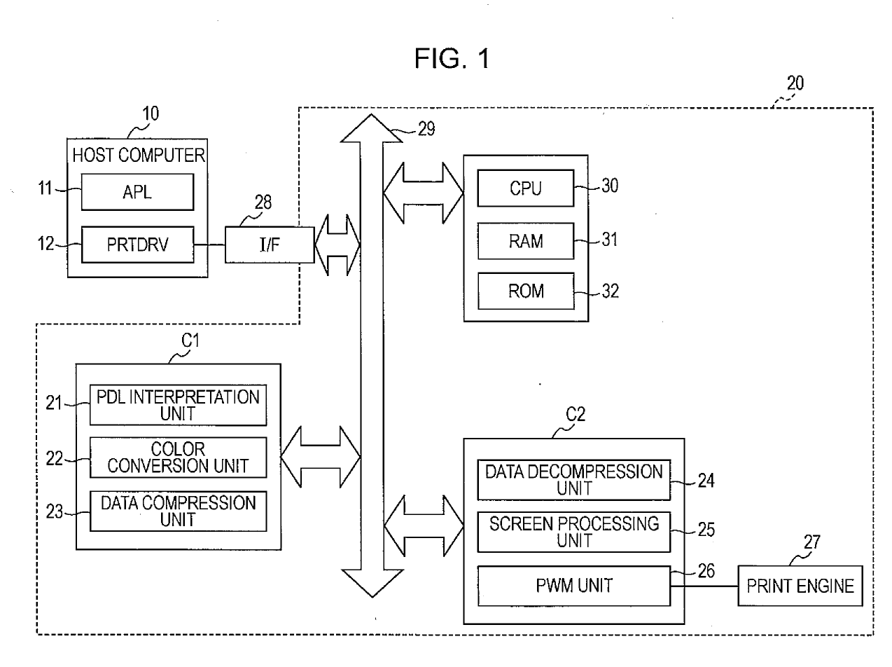

With reference to the accompanying drawings, an exemplary embodiment of the present invention will now be explained in detail. In the following description of an exemplary embodiment of the invention, a laser printer is taken as a non-limiting example of an image processing apparatus that is provided with an image processing controller according to an aspect of the invention. Needless to say, the laser printer described below may be built as an independent printer unit or a component of, for example, a copying machine or other various kinds of apparatuses. FIG. 1 is a block diagram that schematically illustrates an example of the configuration of a laser printer according to an exemplary embodiment of the invention. As illustrated in FIG. 1, a host computer 10 is connected to a laser printer 20 via an interface unit (I/F) 28. The laser printer 20 performs printing on a print target medium such as a sheet of printing paper or the like on the basis of print data that is transmitted from the host computer 10 to the laser printer 20.

The host computer 10 is provided with an application program 11 and a printer driver 12. The application program is hereafter abbreviated as APL. The printer driver is hereafter abbreviated as PRTDRV. The APL 11 is run for creating text data (e.g., alphabetic data or character data), graphic data, bitmap data, and the like. The created data is inputted to the PRTDRV 12. The PRTDRV 12 generates image data D. Then, the PRTDRV 12 outputs the image data D together with a print job to the laser printer 20.

The image data D is sometimes created with the use of page description language (PDL). The PDL is a language that is used for describing, when a document, an image, or the like that has been created on a computer is printed, an output image that is provided to a printer so as to give instructions to the printer. An example of the PDL is Postscript (which is a registered trademark of Adobe Systems, Inc.). It is possible to create a bitmap image without depending on the resolution of a printer from the PDL, which is made up of character position information, graphic position information, format information, and the like. Needless to say, the image data D that is inputted from the PRTDRV 12 is not limited to one that is described in the PDL. For example, it may be bitmap image data such as RGB data, CMYK data, or the like that is made up of a plurality of pixels arrayed in a grid pattern, a honeycomb pattern, or the like, where each of the plurality of pixels represents gradation, that is, tone that is to be reproduced. Though the image data D is not always created with the use of the page description language, in the following description of the present embodiment of the invention, it is assumed that the image data D is the PDL data.

The laser printer 20 is provided with a first control unit C1, a second control unit C2, the I/F 28, a CPU 30, a RAM 31, a ROM 32, and a print engine 27. The laser printer 20 is further provided with a bus 29, which connects the components of the laser printer 20 described above with one another so as to enable internal communication therebetween. The first control unit C1 includes a color conversion unit 22 and a data compression unit 23. The second control unit C2 includes a data decompression unit 24, a screen processing unit 25, and a PWM unit 26. The CPU 30 executes a control program that is stored in the ROM 32 while using the RAM 31 as a work area. The CPU 30 controls each of the first control unit C1, the second control unit C2, and the print engine 27 so as to control the entire operation of the laser printer 20.

The image data D that has been inputted from the PRTDRV 12 is supplied to a group of arithmetic processing devices that is made up of the CPU 30, the RAM 31, and the ROM 32. The CPU 30, the RAM 31, and the RON 32 may be hereafter correctively referred to as arithmetic processing unit. The inputted image data D is stored in the RAM 31. Then, the CPU 30 reads the stored data out of the RAM 31 and transforms (e.g., rasterizes or converts) the vector data including format, graphics, characters, and the like into raster data. A color space after the vector-to-raster transformation depends on the content of an input file. It is typically an RGB color space or a CMYK color space. The raster data obtained as a result of the vector-to-raster transformation, which may be hereafter referred to as rasterized data, is inputted into the color conversion unit 22. Although it is assumed in the description of the present embodiment of the invention that the color conversion unit 22 of the first control unit C1 performs color conversion processing, which will be explained later, the color conversion processing may be performed at the arithmetic processing unit. If such a modified configuration is adopted, the rasterized data is inputted not into the color conversion unit 22 but into the data compression unit 23. It is not always necessary that PDL interpretation should be performed at the arithmetic processing unit. That is, the PDL interpretation may be performed at other functional block. A PDL interpretation unit that performs, as its dedicated function, PDL interpretation processing may be provided in the first control unit C1. For example, a logical operation circuit or the like may be provided in the first control unit C1 as a dedicated PDL interpretation unit.

The raster data represents an aggregate of pixels that are arrayed in a grid pattern, a honeycomb pattern, or the like. The raster data includes color information and image attribute information for each of the plurality of pixels. Assuming that the data is not monochrome one, the color information is 8-bit gradation data for each of RGB or 8-bit gradation data for each of CMYK. The image attribute information is attribute data such as so-called X channel, α channel, or the like. In a case where the image attribute information includes the X channel attribute data, identification information that indicates which one of a plurality of object types (e.g., a character image, a graphic image, a so-called “image” image, and the like) applies to the corresponding pixel data is described therein. That is, for the X channel, the identification information that indicates the type of an object that is made up thereof is described for each pixel. In a case where the image attribute information includes the α channel attribute data, the transparency information of the corresponding pixel data is described therein. The image attribute information is used, for example, for screen selection in halftone processing. The image attribute information might be used also for the purpose of selecting a color conversion table. In the following description of an exemplary embodiment of the invention, RGBX data is taken as an example of the raster data that is inputted into the color conversion unit 22.

The color conversion unit 22 converts the raster data into the color space of the laser printer 20, for example, a CMYK color space. That is, the color conversion unit 22 converts the data that is represented in the RGBX format for each pixel into one that is represented in the CMYKX format. The color conversion unit 22 performs color conversion processing so as to basically bring a color that is defined at input into agreement with the output color of a printer. However, since-non-linearity compensation, gamut compression, total coverage limitation removal and the like are also performed, the input color is not always in agreement with the output color. The gamut compression processing is performed so as to reduce a difference between input gamut and output gamut. The total coverage limitation removal is performed so as to lift restrictions on the total coverage. The CMYK data obtained as a result of the conversion is outputted to the data compression unit 23. In the following description of this specification, the raster data that is converted into the color space of the laser printer 20 is simply referred to as CMYK data.

The data compression unit 23 performs compression processing on the CMYK data so as to reduce or eliminate unwanted redundancy (i.e., reduce information entropy), thereby reducing the file size of the CMYK data. Before performing the compression processing described above, the data compression unit 23 renders a few or more low order bits (i.e., lower-order bits) of the CMYK data redundant in accordance with a predetermined rule so as to increase the data compression ratio thereof.

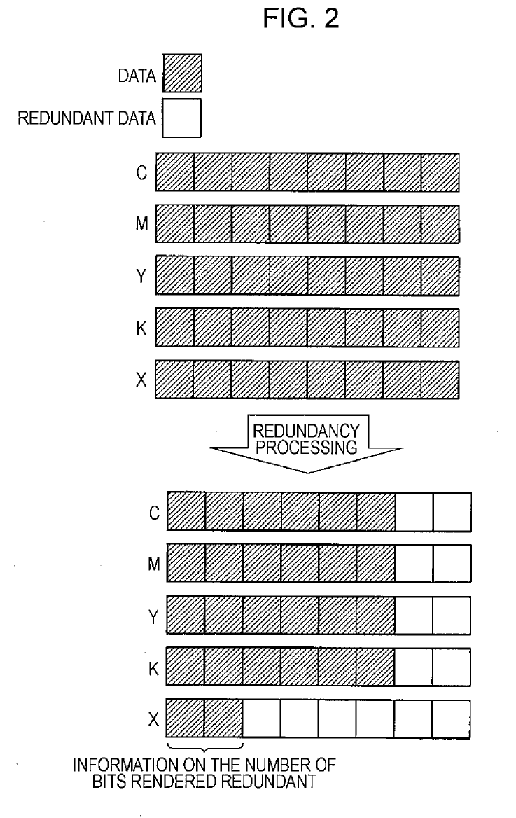

FIG. 2 is a diagram that schematically illustrates an example of the concept of redundancy processing according to an exemplary embodiment of the invention. The redundancy processing is performed by, for example, putting a few or more low order bits of the CMYK data into a missing state In this redundancy processing, each of a few or more low order bits of the CMYK data is replaced with zero, which constitutes a missing bit. Then, the data compression unit 23 records the number of bits put into a missing state as a result of the substitution of zero therefor, that is, the number of bits rendered redundant, in the data area of the image attribute information. Thereafter, the data compression unit 23 performs the data compression processing. When the data compression unit 23 records the number of bits rendered redundant therein, data that is not to be used in subsequent processing may be deleted from the image attribute information so as to further render the data redundant. For example, if processing different from one to another depending on the attribute of an image will not be performed in subsequent screen processing, which will be explained later, it suffices to render all bits of the image attribute information missing and record the number of bits rendered redundant therein.

The same operation/working-effect as above can be obtained for image data that does not have the X channel as long as the image data has the a channel, that is, the transparency information of the image, which is achieved by recording the number of bits rendered redundant in the a channel. Note that it is possible to record the number of bits rendered redundant in the a channel because the a channel will also not be used after the completion of color conversion. It is conceivable that the number of bits that are put into a missing state is changed depending on data amount. For example, in a case where image data that has a relatively high resolution is inputted, the amount of data for one page is relatively large. Therefore, when image data that has a high resolution is inputted, it is necessary to increase a data compression ratio. Accordingly, data transfer will not be performed in time unless the number of missing bits is increased. If the data transfer is not performed in time, the print engine 27, which performs subsequent processing, will suffer an overrun failure. For this reason, it is preferable that the number of bits that are put into a missing state should be large for data that has a high resolution whereas the number of bits that are put into a missing state should be small for data that has a low resolution. The number of missing bits is determined on the basis of a bus transfer speed, which constitutes a predominant determination factor. In addition, memory capacity as well as the processing speed of the data decompression unit 24, which will be explained later, may be taken into consideration as additional factors in the determination of the number of missing bits.

Or, it is conceivable to change the number of bits that are put into a missing state depending on the number of bits of data irrespective of the resolution thereof. That is, it is conceivable to change the number of missing bits even for the same resolution depending on the number of bits of data. For example, it is conceivable to put two bits, more specifically, the lowest-order bit and the second bit as counted from the lowest-order bit (i.e., the second lowest-order bit), into a missing state when 8-bit data is inputted whereas the lowest-order bit only is put into a missing state when 7-bit data is inputted. In this example, if the inputted data is 6-bit data or lesser, no bit is put into a missing state. Or, needless to say, as another modification example, it is possible to put a predetermined fixed number of low order bits into a missing state regardless of the number of bits of data. For example, it is possible to always put two low order bits into a missing state irrespective of the number of bits of data. If the number of missing bits does not depend on the number of bits of inputted data as in the modified example described above, it is possible to ensure that a subsequent processing block knows the number of missing bits though the number of bits rendered redundant is not recorded therein, which eliminates a need for communicating any information on the number of bits to the subsequent processing block.

Or, the number of bits rendered redundant may be changed on the basis of the image attribute information. For example, the number of bits rendered redundant may be relatively large for each pixel to which the image attribute information that indicates a character image is affixed (e.g., four low order bits) whereas the number of bits rendered redundant may be relatively small for each pixel to which the image attribute information that indicates a so-called “image” image is affixed (e.g., two low order bits). This means that the degree of redundancy is set high for each of pixels that make up such a type of an object that does not require continuous tone (i.e., multi-tone reproduction, large-number gradation/grayscale representation) whereas the degree of redundancy is set low for each of pixels that make up such a type of an object that requires continuous tone. Although it might not be necessary to specifically mention here, no redundancy may be provided for each of pixels that make up such a type of an object that requires continuous tone. That is, it is a workable alternative to completely skip the redundancy procedures explained above for each of pixels that make up such a type of an object that requires continuous tone.

Compressed data, which is outputted from the data compression unit 23, is sent to the RAM 31 via the bus 29 and then buffered thereat. When the storing of print data for one page has been completed in the buffer, the transferring of the compressed data to the data decompression unit 24 is started; meanwhile, the second control unit C2 starts to perform print processing in synchronization with the operation of the print engine 27. Since the print data is temporarily buffered as explained above, it is possible to transfer the data to the print engine 27 without pause or interruption in a continuous manner at a predetermined speed on a page-by-page basis, that is, for each page.

A buffer transfer speed (i.e., transfer rate) and a data compression/decompression operation speed (i.e., computing speed) are compared with each other here. Generally speaking, a communication speed is lower than a computation speed. It is assumed that this relation applies to the present embodiment of the invention. Specifically, the transfer speed of the bus 29 is lower than the computing speed of the second control unit C2 (e.g., the data decompression speed of the data decompression unit 24). In the process of the transferring of print data from the RAM 31 to the print engine 27, the rate-limiting factor (i.e., rate-determining step/stage) of the data transmission speed thereof is the transfer speed of the bus 29. That is, as the data compression ratio increases, so does the transfer speed of the print data to the print engine 27.

The data decompression unit 24 decompresses the compressed data and then outputs the decompressed data to the screen processing unit 25. Needless to say, the data decompression unit 24 performs the data decompression processing on the basis of the same algorithm as that used for the data compression processing of the data compression unit 23.

The screen processing unit 25 performs missing-bit complementing processing, γ-correction processing, and halftone processing. The missing bit complementation is processing that is performed for complementing bits that were put in a missing state by the data compression unit 23. The gamma correction is processing that is performed for converting 8-bit image data into 3-bit driving pulse width data. The halftone processing is performed for forming halftone dots. Specifically, the screen processing unit 25 compares image data with each of a plurality of threshold values Th1, Th2, . . . , Th7. The screen processing unit 25 converts the data into a value according to the result of the comparison and performs the halftone processing. On the other hand, the screen processing unit 25 performs the γ-correction processing by adjusting the threshold interval of the values Th1, Th2, . . . , Th7.

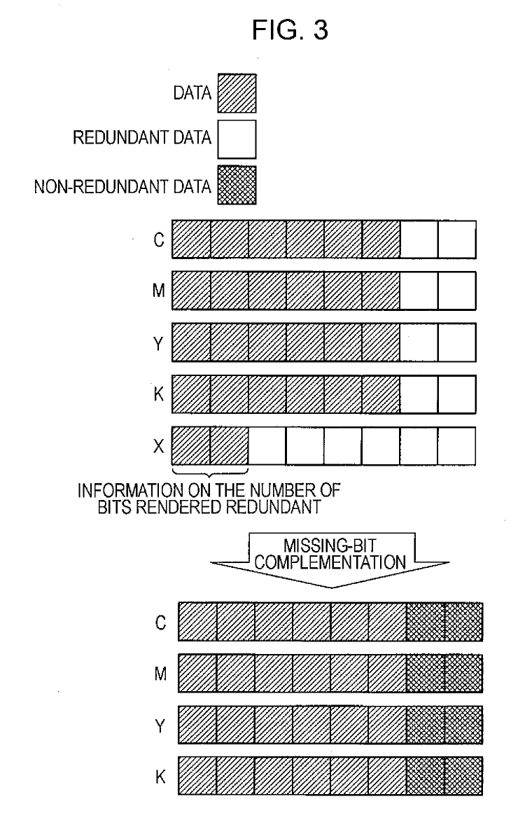

FIG. 3 is a diagram that schematically illustrates an example of the concept of missing-bit complementing processing according to an exemplary embodiment of the invention. As understood from FIG. 3, the screen processing unit 25 refers to the X channel so as to obtain information on the number of missing bits. Then, the screen processing unit 25 generates noise whose number in terms of bit corresponds to the number of missing bits. Then, the screen processing unit 25 adds the generated noise to the low order bits of image data. That is, the screen processing unit 25 places values in the low order bit spaces of the bits that were rounded off through bit-missing processing at the time of data compression, thereby reducing discontinuity in tone. Since the gradation discontinuity is reduced, it is possible to effectively avoid tone jump. After the completion of the missing-bit complementing processing explained above, the screen processing unit 25 performs the γ-correction processing and the halftone processing on the bit-complemented data.

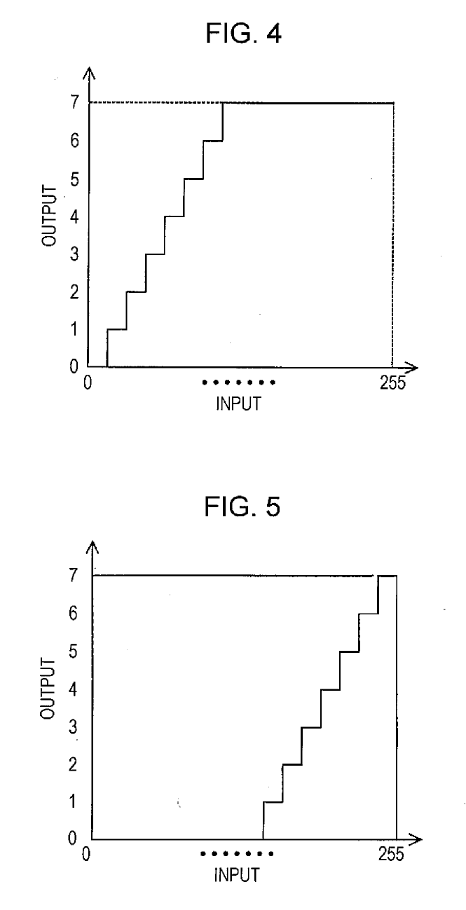

Each of FIGS. 4, 5, and 6 is an input/output curve diagram that shows an example of threshold values and a γ-correction table, which utilizes the threshold values, according to an exemplary embodiment of the invention. The γ-correction table illustrated in each of these drawings is used for converting 8-bit data in 256 grayscale levels into 3-bit 8-grayscale driving pulse data. At each point where the level of input data exceeds the threshold, the level of output data increments by one grayscale step.

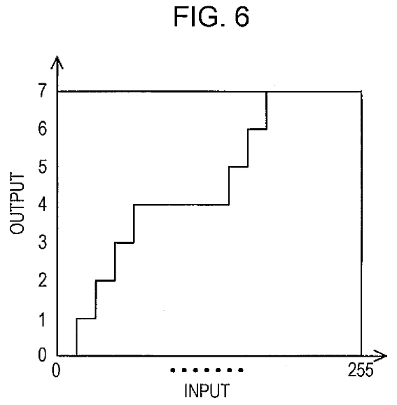

The γ-correction table illustrated in FIG. 4 represents an exemplary case where the threshold values Th1, Th2, . . . , Th7 are set at relatively small values. The gamma curve of this figure corresponds to one that increases output values with respect to input values on the whole as indicated by a broken line. The γ-correction table illustrated in FIG. 5 represents an exemplary case where the threshold values Th1, Th2, . . . , Th7 are set at relatively large values. The gamma curve of this figure corresponds to one that decreases output values with respect to input values on the whole as indicated by a broken line. The γ-correction table illustrated in FIG. 6 represents an exemplary case where the threshold values Th1, Th2, . . . , Th7 are set at irregular intervals. The gamma curve of this figure corresponds to a so-called S curve that enhances a low grayscale level region while dis-enhancing a high grayscale level region.

When performing data conversion with the use of the γ-correction table that has the γ-characteristics explained above, the screen processing unit 25 superposes random noise on each of the threshold values Th1, Th2, . . . , Th7 so as to ensure that driving pulse width data obtained after the data conversion has irregular variations. That is, even when the input data has the same value, the output value is distributed in a random manner within the range of a noise width. Since the input data is converted into the driving pulse width data while reducing discontinuity in tone that occurs through half-toning, it is possible to effectively make tone jump hard to be noticed.

Next, an explanation is given as to how noise is generated. The noise that is added as a complement to the missing bits and the noise that is superposed on the threshold values can be generated with the use of a noise matrix that outputs random noise in accordance with the position (x, y) of a pixel. Or, the noise can be generated with the use of a pseudo-random number generation circuit. In the latter case, a well-known pseudo-random number generation method including but not limited to a middle-square method, a mixed linear congruential method, a Lagged Fibonacci method, a Knuth algorithm (for example, refer to “The art of computer programming”, the third edition, 1997), a Mersenne prime pseudo-random number generation method, an M-sequence (i.e., maximal length sequence) pseudo-random number generation method, or a Gold sequence pseudo-random number generation method can be used. If the circuit size of a pseudo-random number generation circuit is taken into consideration, it is preferable to adopt a method that does not use multiplication because it is advantageous over a method that uses multiplication, the latter of which includes the middle-square method, the mixed linear congruential method, and the like. In particular, the M-sequence pseudo-random number generation method, the circuit of which can be configured as a shift register, is a preferable choice because it is easy to design a generation circuit while achieving a small circuit size. Moreover, the M-sequence pseudo-random number generation method has another advantage in that repetition is less conspicuous because of the long cycle of the random number thereof. For example, if one that has the following characteristic polynomial (1) is used, it is possible to configure a generation circuit with the use of a 31-bit shift register and one exclusive-OR circuit only.

f(x)=x³¹+z³+1 (1)

A method for generating pseudo-random numbers on the basis of an M-sequence is described in, for example, “The collected papers of The Society of Instrument and Control Engineers, vol. 2-4, pages 283-288, 1966”.

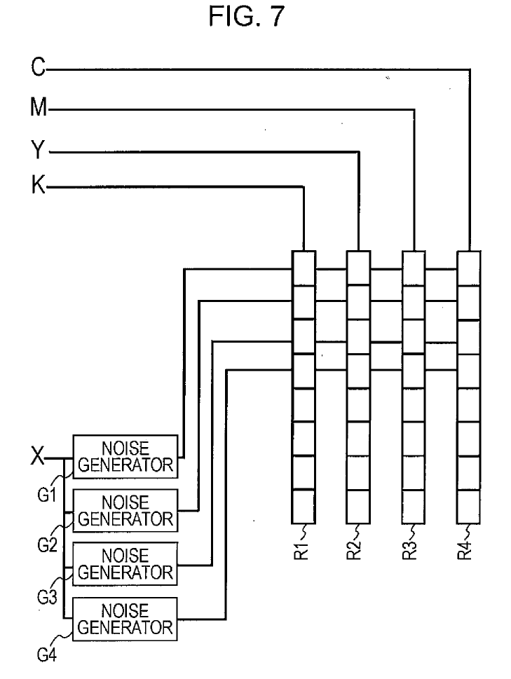

FIG. 7 is a diagram that schematically illustrates a configuration example for performing missing-bit complementing processing in screen processing according to an exemplary embodiment of the invention. In the configuration example of FIG. 7, the screen processing unit 25 is provided with noise generators G1, G2, G3, and G4 and registers R1, R2, R3, and R4. Information on the number of missing bits recorded in the X channel is inputted into each of the noise generators G1 to G4. On the other hand, 8-bit data for each color component of C, M, Y, and K is inputted into the corresponding one of the registers R1 to R4. Among these noise generators G1 to G4, noise generator(s) corresponding to the inputted missing bit(s) generates noise so that the missing-bit complementation input is performed for the register. Since the CMYK values related to the information recorded in the X channel, which has been inputted into the noise generators G1 to G4, are stored in the registers R1 to R4, it follows that the generated noises are added to the missing bits of the CMYK values. The gamma correction and the halftone processing are performed on the CMYK data that has been subjected to the missing-bit complementing processing explained above. In the example illustrated in FIG. 7, the number of bits to which noise is added is assumed to be four bits, or, more specifically, four low order bits of the registers. Notwithstanding the above, however, the number of bits to which noise is added may be modified within a range from one to six. The number of noise generators is increased or decreased in accordance with the modified number of bits to which noise is added.

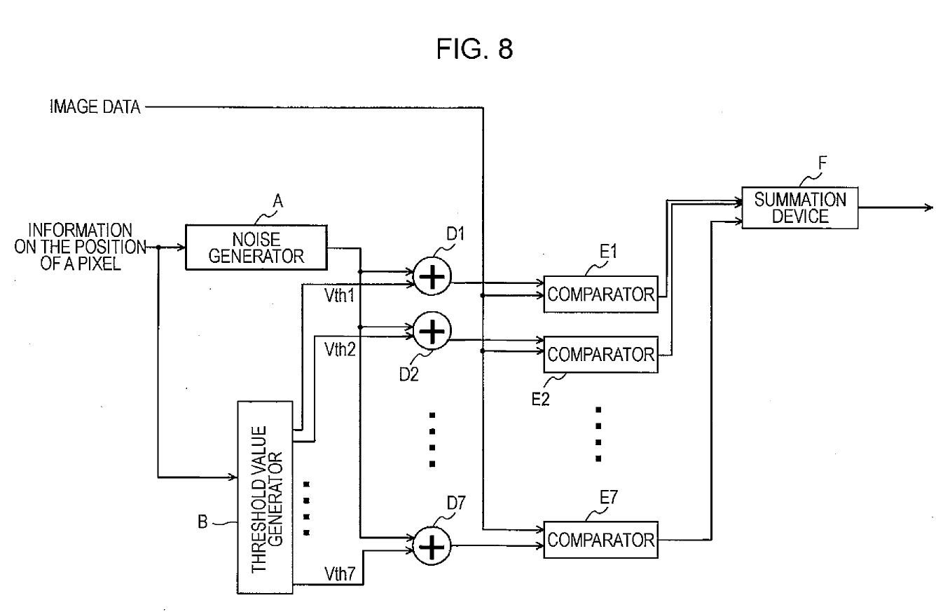

FIG. 8 is a diagram that schematically illustrates a configuration example for performing γ-correction processing and halftone processing according to an exemplary embodiment of the invention. In the configuration example of FIG. 8, the screen processing unit 25 is provided with a noise generator A, a threshold value generator B, adders D1, D2, . . . , D7, comparators E1, E2, . . . , E7, and a summation device F. The noise generator A outputs pseudo-random noise in accordance with the x-y position of a pixel. The threshold value generator B outputs threshold values Vth1, Vth2, . . . , Vth7 in accordance with the x-y position of the pixel. The adders D1, D2, . . . , D7 add the noise generated by the noise generator A to the threshold values Vth1, Vth2, . . . , Vth7 generated by the threshold value generator B, respectively. Each of the comparators E1, E2, . . . , E7 compares the output value of the corresponding one of the adders D1, D2, . . . , D7, that is, the threshold value with the addition of the noise, with the pixel data, and then outputs the result of comparison. For example, the comparator outputs “1” if the pixel data is greater than the noise-added threshold and outputs “0” if the pixel data is not greater than the noise-added threshold. Then, the summation device F sums up the comparison results of the comparators E1, E2, . . . , E7 so as to convert the input data into pulse width data of any one tone value (i.e., gradation value or grayscale value). The summation result is outputted to the PWM unit 26.

The PWM unit 26 generates driving pulse data from the pulse width data that has been inputted from the screen processing unit 25 into the PWM unit 26. Then, a driving pulse signal is generated at a pulse width modulation element on the basis of the driving pulse data.

A laser diode of the print engine 27 generates a beam of laser light in accordance with the driving pulse signal. The laser beam is scanned on a photosensitive drum. Toner adheres to a virtual dot that has been subjected to the irradiation of the laser beam in each pixel. As a result, a dot is formed in each pixel. Then, the dot is transferred to a print target medium such as a sheet of printing paper. Each developed dot constitutes a halftone dot. In this way, halftone reproduction is achieved, depending on the area of the halftone dot.

As explained in detail above, the laser printer 20 according to the present embodiment of the invention includes the data compression unit 23 that renders a given number of (i.e., a few or more) low order bits of the image data D redundant, includes information on the number of bits rendered redundant in the image data D, compresses the image data that has been subjected to redundancy processing mentioned above, and then stores the compressed image data into the RAM 31, the data decompression unit 24 that acquires the image data stored in the RAM 31 via the bus 29 when the amount of the image data stored in the RAM 31 reaches a predetermined amount and then decompresses the image data acquired therefrom, and the screen processing unit 25 that obtains the information on the number of bits rendered redundant included in the image data that has been subjected to decompression processing mentioned above, replaces the given number of low order bits of the decompressed image data with non-redundant data, and then inputs the image data into the PWM unit 26. With such a configuration, the laser printer 20 according to the present embodiment of the invention makes it possible to avoid the data creation speed of the PDL interpretation unit 21 from affecting the processing speed of the second control unit C2 and thus the processing speed of the print engine 27. Therefore, the print engine 27 can perform continuous print processing without interruption or delay. In addition, the laser printer 20 according to the present embodiment of the invention makes it further possible to improve the tone characteristics of image data that is inputted into the second control unit C2.

It should be particularly noted that the scope of the present invention is not limited to any of exemplary embodiments and variation examples described above. For example, a modified configuration in which any of constituent elements disclosed in the foregoing exemplary embodiments or the foregoing variation examples are replaced with each other or one another or a combination thereof is changed or modified is also included in the scope of the invention. Or, as another example, a modified configuration in which any of non-essential constituent elements disclosed in the foregoing exemplary embodiments or the foregoing variation examples is replaced with one or more of known art or a combination thereof is replaced with that of known art is also included in the scope of the invention.

The entire disclosure of Japanese Patent Application No. 2008-199583, filed Aug. 1, 2008 is expressly incorporated by reference herein.

What is claimed is:

1. An image processing controller that inputs, into a processing unit that processes image data that represents a tone for each pixel in a non-interruptive manner by a predetermined amount at a time, the image data via a bus that offers a predetermined transfer speed, the image processing controller comprising:
a first substituting section that renders a given number of low order bits in a tone value of the image data redundant and includes information on the number of bits rendered redundant in the image data;
a storing section that stores the image data;
a compressing section that compresses the image data that has been subjected to redundancy processing mentioned above and then stores the compressed image data into the storing section;
a decompressing section that acquires the image data stored in the storing section via the bus when the amount of the image data stored in the storing section reaches the predetermined amount and then decompresses the image data acquired therefrom; and
a second substituting section that obtains the information on the number of bits rendered redundant included in the image data that has been subjected to decompression processing mentioned above, replaces the given number of low order bits of the decompressed image data with non-redundant data, and then inputs the image data into the processing unit.

2. The image processing controller according to claim 1, wherein each pixel of the image data has information that indicates a type of an object that is made up of the pixels; and the first substituting section changes the number of bits rendered redundant depending on the type of the object.

3. The image processing controller according to claim 1, wherein each pixel of the image data has information that indicates a type of an object that is made up of the pixels; and the first substituting section sets the number of bits rendered redundant for pixels that make up an object whose type is a character image at a value that is larger than a value that is set for pixels that make up an object whose type is a picture image.

4. The image processing controller according to claim 1, wherein each pixel of the image data has information that indicates a type of an object that is made up of the pixels; and the first substituting section renders a given number of low order bits of the image data redundant for pixels that make up an object whose type is a character image whereas the first substituting section does not perform the redundancy processing for pixels that make up an object whose type is a picture image.

5. The image processing controller according to claim 1, wherein the first substituting section includes the information on the number of bits rendered redundant in attribute information description bits of the image data.

6. An image processing controller that inputs, into a processing unit that processes image data that represents a tone for each pixel in a non-interruptive manner by a predetermined amount at a time, the image data via a bus that offers a predetermined transfer speed, the image processing controller comprising:
a first substituting section that renders a predetermined number of low order bits in a tone value of the image data redundant;
a storing section that stores the image data;
a compressing section that compresses the image data that has been subjected to redundancy processing mentioned above and then stores the compressed image data into the storing section;
a decompressing section that acquires the image data stored in the storing section via the bus when the amount of the image data stored in the storing section reaches the predetermined amount and then decompresses the image data acquired therefrom; and
a second substituting section that replaces the predetermined number of low order bits of the image data that has been subjected to decompression processing mentioned above with non-redundant data and then inputs the image data into the processing unit.

7. An image processing apparatus comprising:
a processing unit that processes image data that represents a tone for each pixel in a non-interruptive manner by a predetermined amount at a time; and
an image processing controller that inputs, into the processing unit, the image data via a bus that offers a predetermined transfer speed, the image processing controller including
a first substituting section that renders a given number of low order bits in a tone value of the image data redundant and includes information on the number of bits rendered redundant in the image data,
a storing section that stores the image data,
a compressing section that compresses the image data that has been subjected to redundancy processing mentioned above and then stores the compressed image data into the storing section,
a decompressing section that acquires the image data stored in the storing section via the bus when the amount of the image data stored in the storing section reaches the predetermined amount and then decompresses the image data acquired therefrom, and
a second substituting section that obtains the information on the number of bits rendered redundant included in the image data that has been subjected to decompression processing mentioned above, replaces the given number of low order bits of the decompressed image data with non-redundant data, and then inputs the image data into the processing unit.
